(19) United States
(12) Patent Application Publication
(10) Pub. No.: US 2025/0074247 A1
(43) Pub. Date: Mar. 6, 2025

(54) SMART POLE CHARGING SYSTEM AND MONITORING METHOD THEREOF

(71) Applicant: Compal Electronics, Inc., Taipei City (TW)

(72) Inventors: Ting-Chi Chang, Taipei City (TW); Chun-Ta Chen, Taipei City (TW); Che-Hsien Lien, Taipei City (TW); Yu-Cheng Lee, Taipei City (TW); Tien-Chun Wang, Taipei City (TW); Chun-Wei Hu, Taipei City (TW)

(21) Appl. No.: 18/381,601

(22) Filed: Oct. 18, 2023

(30) Foreign Application Priority Data
Aug. 28, 2023 (TW) 112132355

(51) Int. Cl. B60L 53/67; B60L 53/30; B60L 53/31

(52) U.S. Cl. CPC B60L 53/67; B60L 53/305; B60L 53/31; B60L 2240/70; B60L 2250/10; B60L 2250/16

(57) ABSTRACT

The present disclosure provides a smart pole charging system and a monitoring method. The database system initiates a configuration according to an original environmental status. The charging module is connected with an electric vehicle and provides the electrical energy to the electric vehicle. The monitoring module monitors a real-time environmental status around corresponding smart pole. The calculating module recognizes the real-time environmental status and outputs a calculation result. The router receives the calculation result. The cloud platform is communicated with the router and the database system. The router transmits the calculation result to the cloud platform through an open charge point protocol. The cloud platform adjusts the configuration form the original environmental status to the real-time environmental status according to the calculation result, so that a user device obtains the configuration of the database system according to the real-time environmental status from the cloud platform through an application interface.

### CROSS-REFERENCE TO RELATED APPLICATION

This application claims priority to Taiwan Patent Application No. 112132355 filed on Aug. 28, 2023, the entire contents of which are incorporated herein by reference for all purposes.

### FIELD OF THE INVENTION

The present disclosure relates to a smart pole, and more particularly to a smart pole charging system and a monitoring method of the smart pole charging system.

### BACKGROUND OF THE INVENTION

The smart pole is a carrier for carrying a streetlight and a small base station and providing services such as intelligent lighting, image monitoring, information displaying, environmental sensing, solar charging, networking, emergency calling, water level monitoring, and being a charging station. However, when the electric vehicle owner utilizes the smart pole to charge the electric vehicle and the electric vehicle owner moves away from the smart pole while waiting for charging, once an emergency situation is occurred around the smart pole, the electric vehicle owner can only use the sentinel function built in the electric vehicle to monitor the external camera. However, the sentinel function built in the electric vehicle is limited to recognize the emergency situation based on the images captured by the external camera of the electric vehicle. Consequently, when the external camera of the electric vehicle cannot capture the angle of the emergency situation occurred, the electric vehicle owner cannot promptly assess the situation and respond, so that there are security concerns while the electric vehicle owner utilizing the smart pole to charge the electric vehicle.

Therefore, there is a need of providing a smart pole charging system and a monitoring method of the smart pole charging system in order to address the above issues encountered by the prior arts.

### SUMMARY OF THE INVENTION

The present disclosure provides a smart pole charging system and a monitoring method of the smart pole charging system. The smart pole charging system of the present disclosure includes a database system, a plurality of smart poles and a cloud platform. Each smart pole utilizes the monitoring module to monitor the real-time environmental status around the corresponding smart pole. The cloud platform is communicated with the router of each smart pole and the database system for receiving the calculation result provided from the router of each smart pole, and adjusting the configuration of the database system from the original environmental status to the real-time environmental status according to the calculation result. The user device obtains the configuration of the database system according to the real-time environmental status from the cloud platform through the application interface. Consequently, when the user recognizes the configuration of the database system according to the real-time environmental status is emergency status through the application interface of the user device, for example, the fire alarm or the abnormal behavior is occurred around the smart pole, and the user can return to the location of the smart pole to move the electric vehicle which is provided with the electrical energy as soon as possible. Moreover, the electric vehicle owner utilizing the other smart pole to provide the electrical energy to the electric vehicle recognizes the configuration of the database system according to the real-time environmental status transmitted from the smart pole around the other smart pole. Consequently, the smart pole charging system of the present disclosure enhances the security of the electric vehicle during charging the electric vehicle and provides more reaction time to prevent the abnormal behavior. Otherwise, when the user wants to recognize the parking information around the smart pole, the user recognizes the configuration of the database system according to the real-time environmental status through the application interface of the user device, so that a number of available parking spaces around the smart pole is recognized immediately. The electric vehicle also can be provided with the electrical energy through the charging module of the smart pole when the electric vehicle is parked. The user experience of the smart pole is enhanced. Moreover, each smart pole obtains the information of the database system from the cloud platform through the open charge point protocol. Consequently, the database system can not only communicate with the smart pole produced by single manufacturer but also communicate with the smart pole produced by different manufacturers. The integration complexity of the smart pole produced by different manufacturer is reduced, and the applicability of the smart pole charging system is enhanced.

In accordance with an aspect of the present disclosure, a smart pole charging system is provided. The smart pole charging system includes a database system, a plurality of smart poles and a cloud platform. The database system initiates a configuration according to an original environmental status. Each of the plurality of smart poles includes a charging module, a monitoring module, a calculating module and a router. The charging module is connected with an electric vehicle and provides an electrical energy to the electric vehicle. The monitoring module monitors a real-time environmental status around corresponding one of the plurality of smart poles. The calculating module recognizes the real-time environmental status and outputs a calculation result correspondingly. The router receives the calculation result. The cloud platform is communicated with the router of each of the plurality of smart poles and the database system. The router of each of the plurality of smart poles transmits the calculation result to the cloud platform through an open charge point protocol. The cloud platform adjusts the configuration of the database system from the original environmental status to the real-time environmental status according to the calculation result, so that a user device obtains the configuration of the database system according to the real-time environmental status from the cloud platform through an application interface.

In accordance with an aspect of the present disclosure, a monitoring method of a smart pole charging system is provided. The monitoring method includes the following steps. Firstly, a database system is provided. A configuration is initiated by the database system according to an original environmental status. Then, a plurality of smart poles is provided. A charging module of each of the plurality of smart poles is connected with an electric vehicle to provide an electrical energy to the electric vehicle. Then, a real-time environmental status around each of the plurality of smart poles is monitored by a monitoring module of corresponding one of the plurality of smart poles. The real-time environmental status is recognized by a calculating module of the corresponding one of the plurality of smart poles to output a calculation result to a router of the corresponding one of the plurality of smart poles. Then, a cloud platform is provided to communicate with the router of each of the plurality of smart poles and the database system. The router of each of the plurality of smart poles transmits the calculation result to the cloud platform with the open charge point protocol. The cloud platform adjusts the configuration of the database system from the original environmental status of the database system to the real-time environmental status according the calculation result. Then, the configuration of the database system from the cloud platform is obtained according to the real-time environmental status through the application interface to a user device.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a system diagram illustrating a smart pole charging system of the present disclosure;

FIG. 2 is a partial communication diagram illustrating the smart pole charging system of FIG. 1;

FIG. 3 is a flowchart illustrating a monitoring method for the smart pole charging system of FIG. 1; and

FIG. 4 is a sequential flowchart illustrating a monitoring method for the smart pole charging system of FIG. 1.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

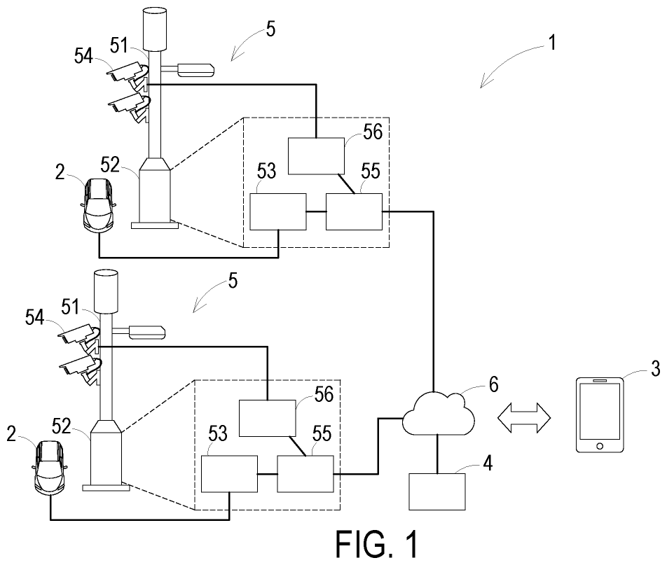

FIG. 1 is a system diagram illustrating a smart pole charging system of the present disclosure. As shown in FIG. 1, the smart pole charging system 1 provides an electrical energy to an electric vehicle 2 and applied to an application interface of a user device 3. For example, the smart pole charging system 1 is applied to the application interface of a smart phone. The user utilizes the smart pole charging system 1 to provide the electrical energy to the electric vehicle 2 and communicates with the smart pole charging system 1 through the application interface of the user device 3. The smart pole charging system 1 includes a database system 4, a plurality of smart poles 5 and a cloud platform 6.

The database system 4 initiates a configuration according to an original environmental status. The plurality of smart poles 5 are disposed on different location of the city, respectively. Each smart pole 5 includes a pole body 51 and a box body 52. The box body 52 is disposed on the ground. The box body 52 is disposed between the pole body 51 and the ground. Each smart pole 5 includes a charging module 53, a monitoring module 54, a router 55 and a first calculating module 56. The charging module 53 is disposed within the box body 52 for charging the electric vehicle 2 when the electric vehicle 2 is connected with the charging module 53. In an embodiment, the charging module 53 is communicated with the electric vehicle 2 through the open charge point protocol (OCPP) so as to recognize the information about a charging electricity, a charging time, a charging original signal and/or a charging end signal. The monitoring module 54 is disposed on the pole body 51 for monitoring a real-time environmental status around the corresponding smart pole 5. The real-time environmental status includes the information about a fire alarm, an abnormal behavior, a number of available parking spaces, a pedestrian flow, a traffic flow, a temperature, a humidity and/or a health status of the smart pole. The first calculating module 56 is disposed within the box body 52 and connected with the monitoring module 54 for recognizing the information of the real-time environmental status provided from the monitoring module 54 and outputting a calculation result according to the real-time environmental status correspondingly. The router 55 is disposed within the box body 52 and connected with the monitoring module 54 and the charging module 53 for receiving the information of the real-time environmental status provided from the first calculating module 56 and the charging information of the electric vehicle 2 provided from the charging module 53. In an embodiment, each smart pole 5 further includes a LED light, a network surveillance camera, an optical radar camera, a smart screen, a speaker and/or a warning light.

The cloud platform 6 is communicated with the router 55 of each smart pole 5 and the database system 4. The router 55 of each smart pole 5 transmits the calculation result to the cloud platform 6 through the open charge point protocol, so that the cloud platform 6 adjusts the configuration of the database system 4 from the original environmental status to the real-time environmental status according to the calculation result. The user device 3 obtains the configuration of the database system according to the real-time environmental status from the cloud platform 6 through the application interface. In some embodiments, when the electric vehicle 2 is connected and provided with the charging module 53 of the smart pole 5, the charging module 53 of the smart pole 5 transmits the information of the real-time environmental status received from the router 55 through the cloud platform 6 to the electric vehicle 2 through the open charge point protocol, so that the electric vehicle 2 obtains the configuration of the database system according to the real-time environmental status from the cloud platform 6 through the application interface.

From above, the smart pole charging system 1 of the present disclosure includes a database system 4, a plurality of smart poles 5 and a cloud platform 6. Each smart pole 5 utilizes the monitoring module 54 to monitor the real-time environmental status around the corresponding smart pole 5. The cloud platform 6 is communicated with the router 55 of each smart pole 5 and the database system 4 for receiving the calculation result provided from the router 55 of each smart pole 5, and adjusting the configuration of the database system 4 from the original environmental status to the real-time environmental status according to the calculation result. The user device 3 obtains the configuration of the database system according to the real-time environmental status from the cloud platform 6 through the application interface. Consequently, when the user recognizes the configuration of the database system according to the real-time environmental status is emergency status through the application interface of the user device 3, for example, the fire alarm or the abnormal behavior is occurred around the smart pole 5, and the user can return to the location of the smart pole 5 to move the electric vehicle 2 which is provided with the electrical energy as soon as possible. Moreover, the electric vehicle owner utilizing the other smart pole 5 to provide the electrical energy to the electric vehicle 2 recognizes the real-time environmental status transmitted from the smart pole 5 around the other smart pole 5. Consequently, the smart pole charging system 1 of the present disclosure enhances the security of the electric vehicle 2 during charging the electric vehicle 2 and provides more reaction time to prevent the abnormal behavior. Otherwise, when the user wants to recognize the parking information around the smart pole 5, the user recognizes the configuration of the database system according to the real-time environmental status through the application interface of the user device 3, so that the number of available parking spaces around the smart pole 5 is recognized immediately. The electric vehicle 2 also can be provided with the electrical energy through the charging module 53 of the smart pole 5 when the electric vehicle 2 is parked. The user experience of the smart pole 5 is enhanced. Moreover, each smart pole 5 obtains the information of the database system 4 from the cloud platform 6 through the open charge point protocol. Consequently, the database system 4 can not only communicate with the smart pole 5 produced by single manufacturer but also communicate with the smart pole 5 produced by different manufacturers. The integration complexity of the smart pole 5 produced by different manufacturer is reduced, and the applicability of the smart pole charging system 1 is enhanced.

In some embodiments, the user controls the application interface of the user device 3, so that the cloud platform 6 controls the operation of the corresponding smart pole 5 through a control signal of the open charge point protocol according to the operation of the application interface. For example, the operation of the LED light, the network surveillance camera, the optical radar camera, the smart screen, the speaker and/or the warning light of the smart pole 5 are controlled and managed. For example, when the user recognizes the real-time environmental status of the database system 4 is emergency status through the application interface, for example, the abnormal image recognition or abnormal artificial damage are occurred around the electric vehicle 2, the user controls the application interface of the user device 3, so that the speaker and/or the warning light are controlled through the open charge point protocol for achieving the warning effect.

In some embodiments, the database system 4 determines the emergency level of the real-time environmental status and provides the emergency level to the cloud platform 6, so that the user device 3 obtains the emergency level corresponding to the real-time environmental status from the cloud platform 6 through the application interface. Preferably but not exclusively, the determining method is an AI-based model determining method or a rule-based model determining method. The AI-based model determining method is trained through the machine learning and determines the emergency level corresponding to the real-time environmental status according to an artificial intelligence module (not shown) of the database system 4. Preferably but not exclusively, the AI-based model determining method is a deep neural network, a convolutional neural network, a recurrent neural network or any artificial neural mode. The rule-based model determining method produces a score according to the real-time environmental status and determines the emergency level according to the score of the real-time environmental status. Table 1 shows the examples of the emergency level determined by the database system of the present disclosure through the rule-based model determining method. In this embodiment, the emergency level determined by the database system 4 is corresponding to the emergency level of the surrounding for the electric vehicle 2. For example, the real-time environmental status of the emergency level includes a fire distance, a fire range and a fire time duration. In the first scene of the table 1, the fire distance is 5 meters (the corresponding score is 10), the fire range is 50 cm×50 cm (the corresponding score is 10), the fire time duration is 60 second (the corresponding score is 5), and the total score of this scene is 25. The database system 4 determines the emergency level of the real-time environmental status of the first scene is high-level emergency. The emergency level of the rest scene can be recognized with the same method, and is not redundantly described hereinafter. Consequently, when the database system 4 receives the calculation result provided from the monitoring module 54, the database system 4 determines the emergency level corresponding to the real-time environmental status according to the information of the real-time environmental status of the calculation result, and provides the emergency level corresponding to the real-time environmental status to the cloud platform 6. Consequently, the user utilizes the application interface of the user device 3 to obtain the emergency level corresponding to the real-time environmental status from the cloud platform 6 so as to handle the current situation according to the emergency level.

| Abnormal | Fire | Fire | Fire time | Total |
|---|---|---|---|---|
| behavior | distance | range | duration | score |
| Scene 1 | 5 meters | 50 cm × 50 cm | 60 seconds | 25 (high-level |
| | (+10) | (+10) | (+5) | emergency) |
| Scene 2 | 10 meters | 20 cm × 20 cm | 30 seconds | 10 (middle- |
| | (+3) | (+5) | (+2) | level |
| | | | | emergency) |
| Scene 3 | 15 meters | 10 cm × 10 cm | 15 seconds | 6 (low-level |
| | (+3) | (+2) | (+1) | emergency) |

Table 1 shows the examples of the emergency level determined by the database system of the present disclosure through the rule-based model determining method.

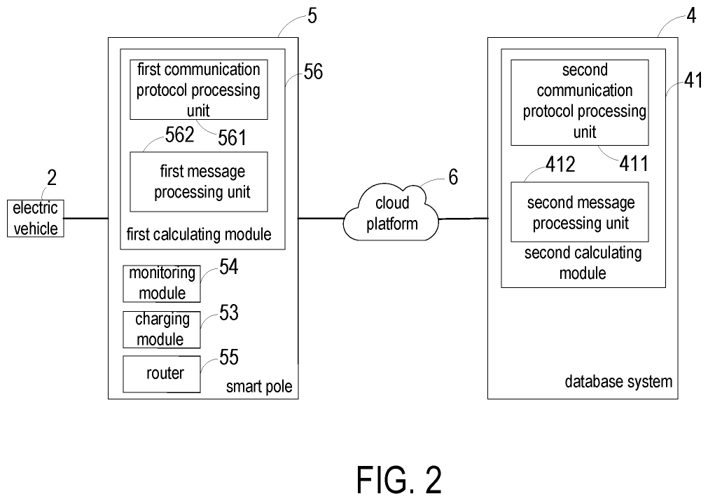

FIG. 2 is a partial communication diagram illustrating the smart pole charging system of FIG. 1. As shown in FIG. 2, when the charging module 53 of the smart pole 5 is communicated with the electric vehicle 2 through the open charge point protocol, the first calculating module 56 of the smart pole 5 obtains a charging information data packet. The charging information data packet includes the version information of the open charge point protocol of the electric vehicle 2. As shown in FIG. 2, the first calculating module 56 of the smart pole 5 includes a first communication protocol processing unit 561 and a first message processing unit 562. The first communication protocol processing unit 561 analyzes the charging information data packet to obtain the version information of the open charge point protocol of the electric vehicle 2. When the charging information data packet further includes an extra information than the open charge point protocol, the first message processing unit 562 processes the charging information data packet including the extra information than the open charge point protocol. The database system 4 includes a second calculating module 41 including a second communication protocol processing unit 411 and a second message processing unit 412. The second communication protocol processing unit 411 analyzes the calculation result, and the second message processing unit 412 analyzes another calculation result which is unable to be analyzed by the second communication protocol processing unit 411.

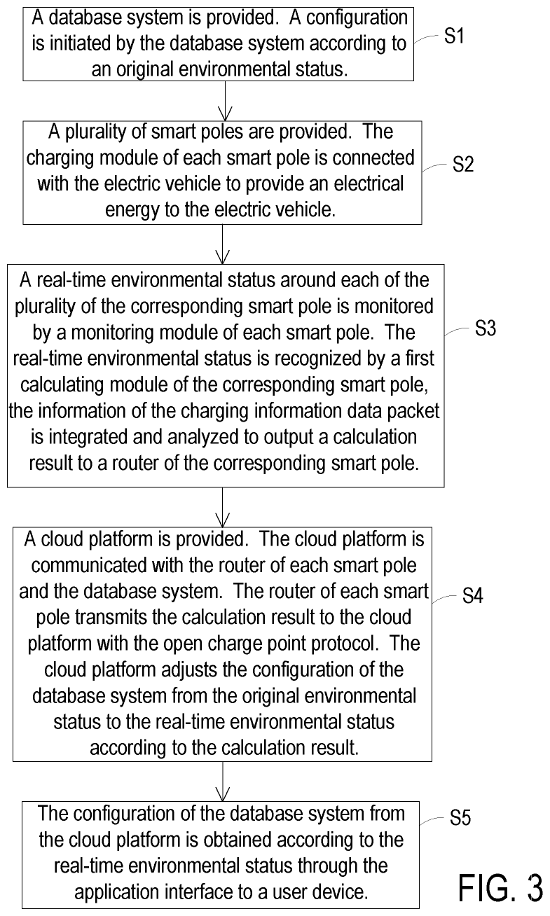

FIG. 3 is a flowchart illustrating a monitoring method for the smart pole charging system of FIG. 1. As shown in FIG. 3, a step S1 is performed. In the step S1, a database system 4 is provided. A configuration is initiated by the database system 4 according to an original environmental status. Then, a step S2 is performed. In the step S2, a plurality of smart poles 5 are provided. The charging module 53 of each smart pole 5 is connected with the electric vehicle 2 to provide an electrical energy to the electric vehicle 2. Then, a step S3 is performed. In the step S3, a real-time environmental status around each of the plurality of the corresponding smart pole 5 is monitored by a monitoring module 54 of each smart pole 5. The real-time environmental status is recognized by a first calculating module 56 of the corresponding smart pole 5, the information of the charging information data packet is integrated and analyzed to output a calculation result to a router 55 of the corresponding smart pole 5. The calculation result includes the information type consistent with the open charge point protocol. Preferably but not exclusively, the calculation result is a java-script object notation (JSON) or an extensible markup language (XML). Then, a step S4 is performed. In the step S4, a cloud platform 6 is provided. The cloud platform 6 is communicated with the router 55 of each smart pole 5 and the database system 4. The router 55 of each smart pole 5 transmits the calculation result to the cloud platform 6 with the open charge point protocol. The cloud platform 6 adjusts the configuration of the database system 4 from the original environmental status to the real-time environmental status according to the calculation result. Then, a step S5 is performed. In the step S5, the configuration of the database system 4 from the cloud platform 6 is obtained according to the real-time environmental status through the application interface to a user device 3.

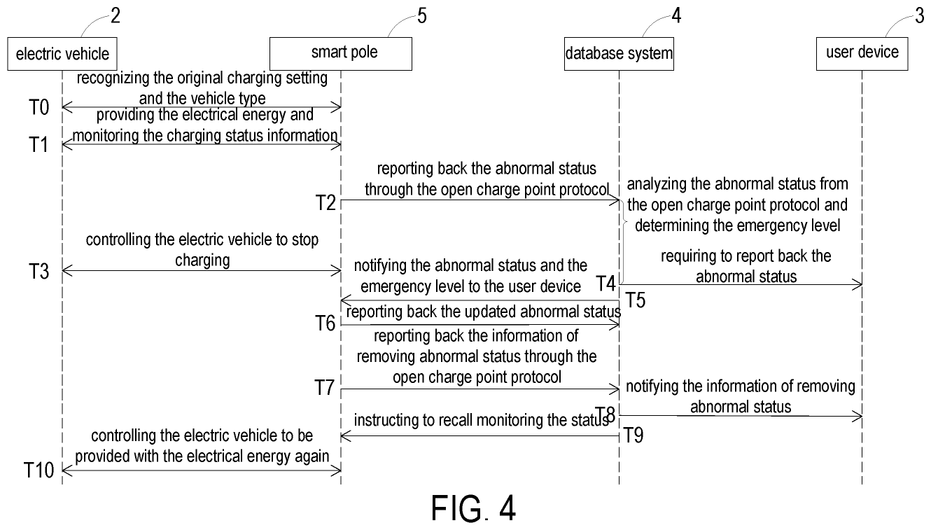

In the following example, the monitoring module 54 of the smart pole 5 monitors the real-time environmental status, and the real-time environmental status is abnormal. FIG. 4 is a sequential flowchart illustrating a monitoring method for the smart pole charging system of FIG. 1. For sampling the figure, FIG. 4 only shows the communication structure between the electric vehicle 2 and the smart pole 5, the communication structure between the database system 4 and the smart pole 5 and the communication structure between the database system 4 and the user device 3, and the communication structure of the cloud platform 6 is omitted. However, it is clear that the database system 4 is communicated with the smart pole 5 through the cloud platform 6 with the open charge point protocol. In the time T0, the smart pole 5 recognizes the original charging setting and the vehicle type of the electric vehicle 2. In the time T1, the smart pole 5 starts to provide the electrical energy to the electric vehicle 2 and monitors the charging status information. In the time T2, the smart pole 5 reports back the abnormal status to the database system 4 through the open charge point protocol. In the time T3, the smart pole 5 controls the electric vehicle 2 to stop charging. During the time T2 to time T4, the database system 4 analyzes the abnormal status reported back from the open charge point protocol and determines the emergency level of the abnormal status. In the time T4, the database system 4 notifies the abnormal status and the emergency level of the abnormal status to the user device 3. In the time T5, the database system 4 requires the smart pole 5 to report back the abnormal status. In the time T6, the smart pole 5 reports back the updated abnormal status to the database system 4. In the time T7, the smart pole 5 reports back the information of removing abnormal status to the database system 4 through the open charge point protocol. In the time T8, the database system 4 notifies the information of removing abnormal status to the user device 3. In the time T9, the database system 4 instructs the smart pole 5 to recall monitoring the status. In the time T10, the smart pole 5 controls the electric vehicle 2 to be provided with the electrical energy again.

According to the above description, the smart pole charging system 1 provides multi-application services. For example, the mart pole charging system 1 provides two kinds of application services as shown below. In the first service, the electric vehicle owner needs to provide the electrical energy to the electric vehicle 2 so as to search the database system 4 from the cloud platform 6 through the application interface. The database system 4 includes the real-time environmental status monitored by the plurality of smart poles 5. Namely, the database system 4 includes the parking information around each smart pole 5 and the operation status of the charging module 53 of the smart pole 5. Consequently, the electric vehicle owner recognizes the environment information around the smart pole 5 according to the real-time environmental status and chooses the corresponding smart pole 5 to provide the electrical energy to the electric vehicle 2. Therefore, the charging requirement of the electric vehicle owner is bypassed with the charging service of the smart poles 5 through the smart pole charging system 1 of the present disclosure so as to enhance the charging efficiency.

In the second service, the monitoring module 54 of the smart pole 5 monitors the abnormal behavior of the real-time environmental status occurred around the corresponding smart pole 5. The smart pole 5 provides the real-time environmental status to the cloud platform 6 and monitors the distance between the abnormal behavior and the smart pole 5 and the range of the abnormal behavior. The smart pole 5 utilizes the cloud platform 6 to transmit the abnormal behavior to the database system 4 through the open charge point protocol. The database system 4 determines the emergency level corresponding to the real-time environmental status according to the information of the real-time environmental status and provides the emergency level to the cloud platform 6. Consequently, the user obtains the emergency level of the real-time environmental status from the cloud platform 6 through the application interface so as to handle the current situation according to the emergency level. For example, when the database system 4 determines the abnormal behavior of the real-time environmental status occurred around any smart pole 5 and the emergency level of the abnormal behavior is corresponding to high level, the database system 4 transmits the emergency level to the cloud platform 6 through the open charge point protocol. The cloud platform 6 transmits the information of the high level to the application interface for the electric vehicle owner who provides the electrical energy to the electric vehicle with the smart pole 5 around the abnormal behavior nearby five meters. The electric vehicle owner recognizes the emergency level of the abnormal behavior corresponding to the high level so as to move the electric vehicle as soon as possible. The cloud platform 6 transmits the information of the middle level to the application interface for the electric vehicle owner who provides the electrical energy to the electric vehicle with the smart pole 5 around the abnormal behavior nearby ten meters. The electric vehicle owner recognizes the emergency level of the abnormal behavior corresponding to the middle level so as to determine whether moving the electric vehicle. Moreover, the monitoring module 54 of the smart pole 5 monitors the status of the equipment of the corresponding smart pole 5. When the equipment of the smart pole 5 is breakdown, the monitoring module 54 transmits the status of the equipment to the database system 4 through the open charge point protocol. Consequently, the maintenance worker can handle the breakdown of the equipment of the smart pole 5 and provide precise breakdown predict and remote diagnosis.

From the above descriptions, the smart pole charging system of the present disclosure includes a database system, a plurality of smart poles and a cloud platform. Each smart pole utilizes the monitoring module to monitor the real-time environmental status around the corresponding smart pole. The cloud platform is communicated with the router of each smart pole and the database system for receiving the calculation result provided from the router of each smart pole, and adjusting the configuration of the database system from the original environmental status to the real-time environmental status according to the calculation result. The user device obtains the configuration of the database system according to the real-time environmental status from the cloud platform through the application interface. Consequently, when the user recognizes the configuration of the database system according to the real-time environmental status is emergency status through the application interface of the user device, for example, the fire alarm or the abnormal behavior is occurred around the smart pole, and the user can return to the location of the smart pole to move the electric vehicle which is provided with the electrical energy as soon as possible. Moreover, the electric vehicle owner utilizing the other smart pole to provide the electrical energy to the electric vehicle recognizes the real-time environmental status transmitted from the smart pole around the other smart pole. Consequently, the smart pole charging system of the present disclosure enhances the security of the electric vehicle during charging the electric vehicle and provides more reaction time to prevent the abnormal behavior. Otherwise, when the user wants to recognize the parking information around the smart pole, the user recognizes the configuration of the database system according to the real-time environmental status through the application interface of the user device, so that the number of available parking spaces around the smart pole is recognized immediately. The electric vehicle also can be provided with the electrical energy through the charging module of the smart pole when the electric vehicle is parked. The user experience of the smart pole is enhanced. Moreover, each smart pole obtains the information of the database system from the cloud platform through the open charge point protocol. Consequently, the database system can not only communicate with the smart pole produced by single manufacturer but also communicate with the smart pole produced by different manufacturers. The integration complexity of the smart pole produced by different manufacturer is reduced, and the applicability of the smart pole charging system is enhanced.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A smart pole charging system, comprising:
a database system initiating a configuration according to an original environmental status;
a plurality of smart poles, wherein each of the plurality of smart poles comprises:
a charging module connected with an electric vehicle and configured to provide an electrical energy to the electric vehicle;
a monitoring module configured to monitor a real-time environmental status around corresponding one of the plurality of smart poles;
a calculating module configured to recognize the real-time environmental status and output a calculation result correspondingly; and
a router configured to receive the calculation result; and
a cloud platform communicated with the router of each of the plurality of smart poles and the database system;
wherein the router of each of the plurality of smart poles transmits the calculation result to the cloud platform through an open charge point protocol, the cloud platform adjusts the configuration of the database system from the original environmental status to the real-time environmental status according to the calculation result, so that a user device obtains the configuration of the database system according to the real-time environmental status from the cloud platform through an application interface.

2. The smart pole charging system according to claim 1, wherein the cloud platform controls an operation of the corresponding one of the plurality of smart poles through a control signal of the open charge point protocol according to an operation of the application interface.

3. The smart pole charging system according to claim 1, wherein the calculating module comprises a first communication protocol processing unit and a first message processing unit, and the charging module of each of the plurality of smart poles obtains a charging information data packet when the charging module is communicated with the electric vehicle through the open charge point protocol.

4. The smart pole charging system according to claim 3, wherein the first communication protocol processing unit analyzes the charging information data packet so as to obtain a version information of the open charge point protocol corresponding to the electric vehicle.

5. The smart pole charging system according to claim 3, wherein the first message processing unit analyzes the charging information data packet when the charging information data packet further comprises an extra information than the open charge point protocol.

6. The smart pole charging system according to claim 1, wherein the database system comprises a second communication protocol processing unit and a second message processing unit, the second communication protocol processing unit analyzes the calculation result, and the second message processing unit analyzes another calculation result which is unable to be analyzed by the second communication protocol processing unit.

7. The smart pole charging system according to claim 1, wherein the database system determines an emergency level according to the real-time environmental status and provides the emergency level to the cloud platform.

8. The smart pole charging system according to claim 1, wherein the cloud platform controls the operation of a LED light, a network surveillance camera, an optical radar camera, a smart screen, a speaker and/or a warning light of the corresponding one of the plurality of smart poles through the open charge point protocol according to an operation of the application interface.

9. The smart pole charging system according to claim 1, wherein the real-time environmental status monitored by the monitoring module includes an information about a fire alarm, an abnormal behavior, a number of available parking spaces, a pedestrian flow, a traffic flow, a temperature, a humidity and/or a health status of each of the plurality of smart poles.

10. A monitoring method of a smart pole charging system, applied to an application interface, and the monitoring method comprising:
(a) providing a database system, and initiating a configuration according to an original environmental status in the database system;
(b) providing a plurality of smart poles, connecting a charging module of each of the plurality of smart poles with an electric vehicle to provide an electrical energy to the electric vehicle;
(c) monitoring a real-time environmental status around each of the plurality of smart poles by a monitoring module of corresponding one of the plurality of smart poles, and recognizing the real-time environmental status by a calculating module of the corresponding one of the plurality of smart poles to output a calculation result to a router of the corresponding one of the plurality of smart poles;
(d) providing a cloud platform to communicate with the router of each of the plurality of smart poles and the database system, wherein the router of each of the plurality of smart poles transmits the calculation result to the cloud platform with the open charge point protocol, and the cloud platform adjusts the configuration of the database system from the original environmental status of the database system to the real-time environmental status according to the calculation result; and
(e) obtaining the configuration of the database system from the cloud platform according to the real-time environmental status through the application interface to a user device.

11. The monitoring method according to claim 10, wherein after the step (e), the cloud platform controls an operation of the corresponding one of the plurality of smart poles through a control signal of the open charge point protocol according to an operation of the application interface.

12. The monitoring method according to claim 10, wherein in the step (d), the database system determines an emergency level according to the real-time environmental status and provides the emergency level to the cloud platform.
